(19) United States
(12) Patent Application Publication
(10) Pub. No.: US 2002/0110235 A1
(43) Pub. Date: Aug. 15, 2002

(54) Private telephone management system and method

(76) Inventors: Al Simpson, Regina (CA); Paul Zoehner, Coquitlam (CA); Gord Reed, Regina (CA); Dennis Elmer Johns, Regina (CA)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 09/779,708

(22) Filed: Feb. 9, 2001

(51) Int. Cl. H04M 1/00; H04M 9/00; H04M 3/00

(52) U.S. Cl. 379/377; 379/387.01

(57) ABSTRACT

An apparatus for adding functionality to a private telephone system, comprising: a processing unit monitoring a telephone line and operable to perform said added functionality; a talk battery; and a switch having an input for a telephone, and an output selectable between an input of said private telephone system and said talk battery, said switch being controlled by said processing unit.

The present invention relates generally to telecommunications, and more specifically, to a private telephone management system and method.

### BACKGROUND OF THE INVENTION

The use of telephones for voice communication is almost pervasive in industrialised nations. Business organisations and institutions, for example, make telephones available to almost all of their employees, who rely on those telephones in the course of their daily work. While each individual telephone in an organisation could be connected directly to the public switched telephone network (PSTN), it is more convenient and less expensive to interconnect an organisation's telephones with an internal private branch exchange (PBX) system, the PBX then being connected to the PSTN.

A PBX allows a number of outside PSTN trunks to be shared by a larger number of internal telephones. Methods of calculating the optimal number of PSTN trunks for one's requirements are well known in the art. While the ratio of telephones to PSTN trunks will vary with the nature and size of the organisation (generally in accordance with the Erlang statistical distribution), a typical PBX in an office or hospital may, for example, have 7 telephones for every 1 PSTN trunk.

PBXs are generally owned and operated by the business organisation or institution rather than the telephone company. Although this is an added cost to the organisation, it is less expensive for a mid- to large-sized organisation to administer PSTN trunks in such a manner, than to have a separate PSTN line for each telephone.

For internal communications, the PBX allows one to forgo the PSTN altogether by directly interconnecting PBX telephones together, and generally allows this to be done using abbreviated dialling. That is, internal calls may be placed by dialling a convenient 3 or 4 digit extension number, rather than a 7 digit NANP (North American Numbering Plan) number as required by the PSTN.

The PBX equipment may also provide switching functions which permit users to gain access to trunk lines, including WATS (wide area telephone service), DDD (direct distance dialling) and the like. Access to these services are generally controlled by use of passwords or account numbers.

An exemplary PBX system 10 is presented in the block diagram of FIG. 1. This system 10 consists of:

the PBX 12, which manages the switching of telephone calls;

a multiple trunk lines 14 that connect the PBX 12 to the PSTN 16;

a console 18 or terminal for a human operator to interface with the PBX 12;

telephones 20; and

multiple PBX lines 22, one per telephone 20, connecting each telephone 20 to the PBX 12.

PBX equipment is, of course, well known in the art, numerous manufacturers providing many types of PBX equipment for virtually every type of business environment.

As an institution grows, it generally requires increased PBX capacity and more advanced features. However, it has been difficult to upgrade existing PBX equipment because of limitations of space, memory storage, functionality and the like.

There are no generic standards so PBXs 12 generally employ proprietary software and hardware; therefore, upgrading such systems is quite expensive. As well, the capacity of a PBX 12 for expansion in terms of functionality or the number of input or output lines, may be limited. In fact it may be impossible to upgrade if an old PBX 12 is no longer supported, or if the expansion requirements go beyond the overall design capacity of the original system.

Software layers are available which run over existing PBXs 12, such as Switchview™, but these layers are expensive as they must be tailored to the specifics of the existing PBX 12. As well, their functionality is limited by that of the underlying PBX 12 platform. Switchview, for example, emulates keystroke inputs at a serial port of the PBX 12, so it is necessarily limited by the existing functionality available.

Some telephone companies offer network based services called Centrex services, which perform the same functionality as the PBX 12, but using the resources of the PSTN 16. While the monthly subscription costs and dedicated PSTN lines of Centrex systems might be cost effective for small organisations, they are more expensive than PBX 12 systems for mid- to large-sized organisations. More important, the user of a Centrex system is limited to the services made available by the telephone company and personalised features cannot be provided.

In addition to their uses in offices and educational institutions, PBXs 12 are often employed in private institutions such as hospitals. The hospital environment is distinguishable from the typical PBX 12 application in that the users of the telephones 20 turn over at a much higher rate.

This high turnover rate has forced hospitals to adopt efficient ways of opening new user accounts in order to maximize the time a visiting patient can access and pay for telephone services. Therefore, systems have been developed which allow new accounts to be set up from the patient's bedside, or to charge costs electronically to credit, debit or pre-paid cards.

In the past, an attendant had to manually program the PBX 12 to accept a new user account. Physical switches or patch cords were often used on older PBX 12 systems to enable telephones, but even recent systems have been using such components to minimize the cost and size of the PBX 12. However, more sophisticated systems now exist with which an attendant can set up an account by entering a password at the patient's bedside. Still many systems require that a service technician be scheduled to make the physical connection from the patient's phone set to the PBX 12—a costly and time-consuming operation. Regardless, the problem of closing the user account still remains.

Patients leave the hospital when they have medical approval to do so, or simply when they wish. Because of its comparative insignificance, the status of the patient's telephone bill is not usually a part of the departure decision, so the PBX attendant is not usually aware that the patient is departing until they have already left. This results in telephones remaining in operation after the patient has left, and outstanding costs against his PBX account not being settled. The patient's PBX account must also be closed so that others may not access it, requiring a manual programming or disconnection exercise complementary to that described above with respect to account set up. Losses in the manual collection of accounts are reported to run as high as 50%, which is clearly unacceptable.

These problems are being exacerbated by the trend toward reduced time of patient stays in hospital. As the length of patient visits decrease, the proportion of telephone downtime rises. This causes a progressive reduction in the revenue stream that hospitals have been accustomed to receiving from their patient telephone systems.

There is therefore a need for a system and method of expanding the capacity and functionality of PBX systems, and in particular, the provision of an improved manner of managing user accounts. This design must be provided with consideration for the cost of and limitations of modifying PBX hardware and software, and the functional demands of particular applications.

### SUMMARY OF THE INVENTION

It is therefore an object of the invention to provide a telephone management system and method which obviates or mitigates at least one of the disadvantages of the prior art.

One aspect of the invention is broadly defined as an apparatus for adding functionality to a private telephone system, comprising: a processing unit monitoring a telephone line and operable to perform said added functionality; a talk battery; and a switch having an input for a telephone, and an output selectable between an input of said private telephone system and said talk battery, said switch being controlled by said processing unit.

An additional aspect of the invention is defined as a system comprising: at least one telephone; a private telephone system; an apparatus for adding functionality to said private telephone system including: a processing unit operable to: monitor a telephone line; and perform said added functionality; a talk battery; and a switch having an input for a telephone, and an output selectable between an input of said private telephone system and said talk battery, said switch being operable to be controlled by said processing unit.

A further aspect of the invention is defined as a line card for adding functionality to a private telephone system, said line card comprising: a processing unit monitoring a telephone line and operable to perform said added functionality; and a switch having an input for a telephone, and an output selectable between an input of said private telephone system and a talk battery, said switch being controlled by said processing unit.

### BRIEF DESCRIPTION OF THE DRAWINGS

These and other features of the invention will become more apparent from the following description in which reference is made to the appended drawings in which:

FIG. 1 presents a block diagram of an exemplary private branch exchange (PBX) system, as known in the art;

FIG. 2 presents a block diagram of an apparatus for adding functionality to a private telephone system in a broad embodiment of the invention;

FIG. 3 presents a flow chart of a method for providing chargeable services in an embodiment of the invention;

FIG. 4 presents a physical layout of an apparatus for adding functionality to a private telephone system in an embodiment of the invention;

FIG. 5 presents an electrical schematic diagram of a line interface circuit in a line card, in a preferred embodiment of the invention;

FIG. 6 presents an electrical schematic diagram of an 8515 micro-controller circuit in a line card, in a preferred embodiment of the invention;

FIG. 7 presents a block diagram of an apparatus for adding functionality to a private telephone system, in a preferred embodiment of the invention; and

FIG. 8 presents a block diagram of a concentrator line card, in a preferred embodiment of the invention; and

FIGS. 9a and 9b present a flow chart of a method of communication in a preferred embodiment of the invention.

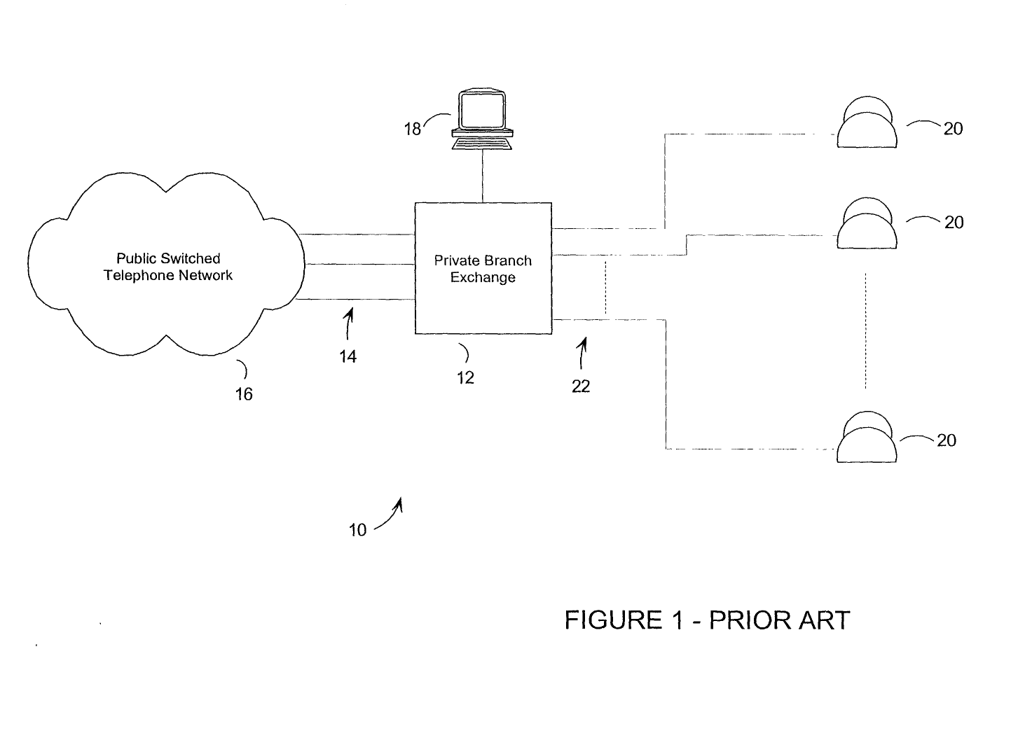

### DESCRIPTION OF THE INVENTION

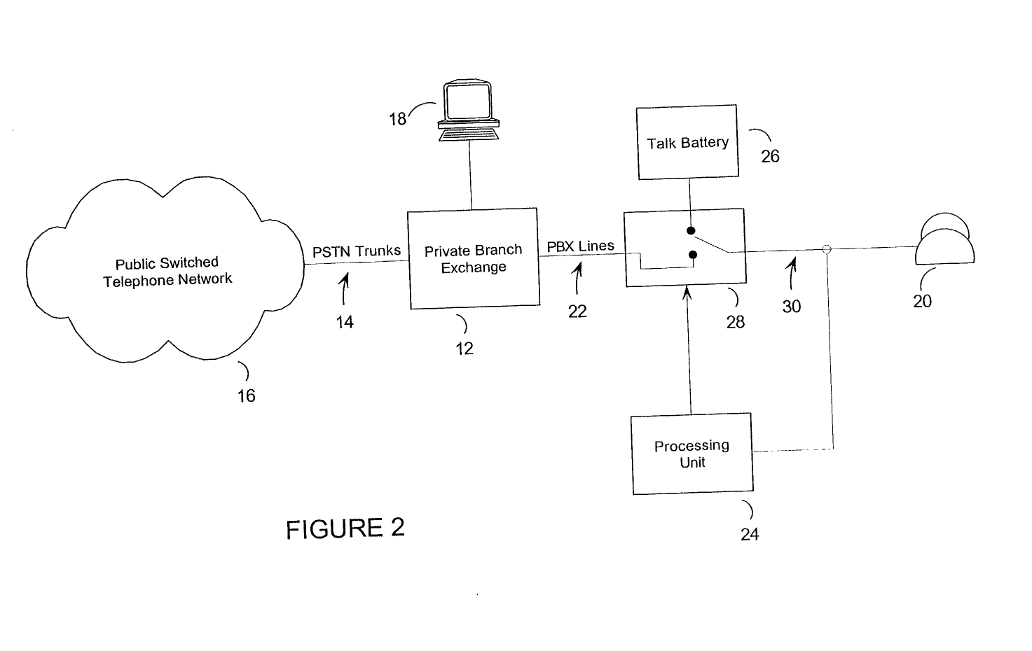

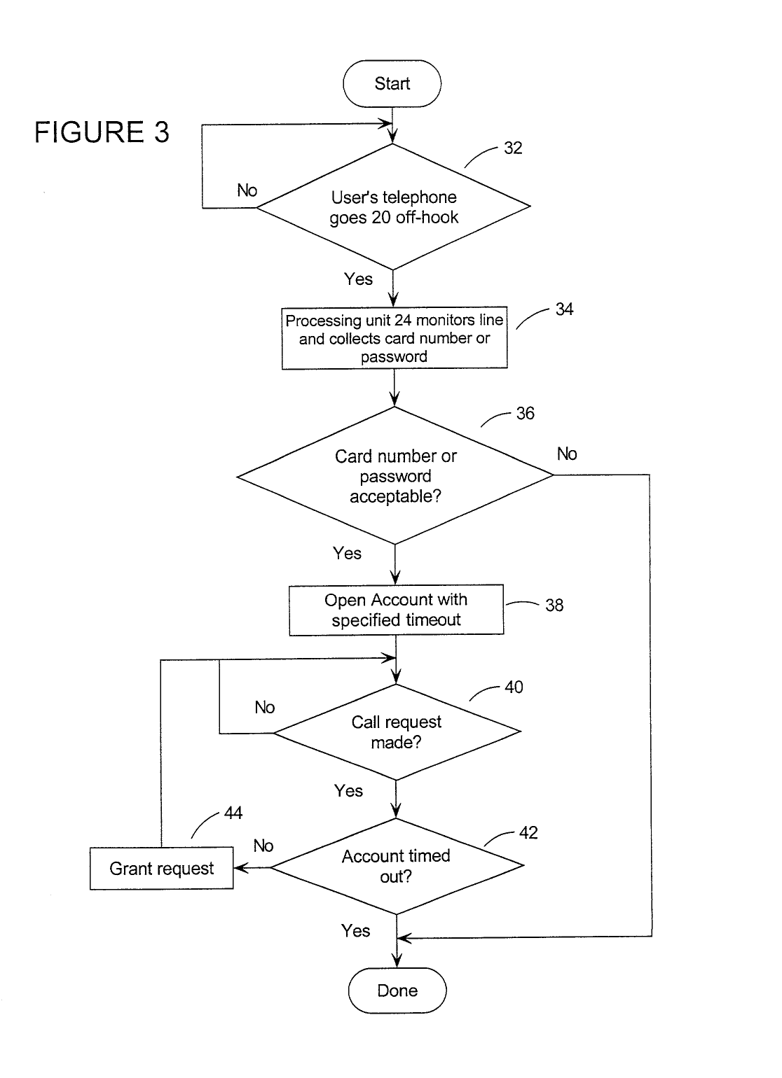

An apparatus which addresses the objects outlined above, is presented as a block diagram in FIG. 2. This figure presents an apparatus which provides new functionality to a private telephone system, consisting of a processing unit 24, a talk battery 26 and a switch 28. The processing unit 24 is operable to monitor a telephone line 30 and to perform the new functionality that is desired. The switch 28 selects whether the telephone 20 is connected to the existing private telephone system, which may be a PBX 12 as shown, or to the talk battery 26. The position of the switch 28 is controlled by the processing unit 24.

While the invention is presented with respect to a PBX 12 system as shown in FIG. 2, it could be applied to any manner of private telephone system including a Centrex based system.

The processing unit 24 may be effected using one of many devices known in the art, that is suitable to provide the functionality being added to the existing PBX system. This would include, for example, one or more micro-controllers, microprocessors, ASICs (application specific integrated circuits) or FPGAs (field programmable gate arrays). Functionality such as dual tone multifrequency (DTMF) encoding and/or decoding, interactive voice response (IVR), digital signal processing (DSP), or similar functionality may be performed by the processing unit 24 or additional electronic components. More details on how such functionality is applied to the invention is provided hereinafter.

The talk battery 26 provides the electrical power that the telephone 20 requires to operate while disconnected from the PBX 12. The nature of the talk battery 26 is therefore dependent on the specific application, and it is well within the skill in the art to design an appropriate talk battery 26 which mimics that of the PBX 12.

The type of switch 28 required also varies with the PBX 12 the invention is being applied to, and generally only requires an input for a telephone 20, and an output selectable between an input of the PBX 12 and the talk battery 26. The PBX lines 22 may consist of two- or four-wire, tip and ring pairs, or may consist of some proprietary configuration. In a two-wire arrangement, for example, a telephony-rated, dual-pole dual-throw (DPDT) switch may be used for switch 28. Often, PBX 12 uses proprietary telephones 20 which may require a special configuration for the switch 28.

This method allows users to set up new accounts automatically, to make long distance telephone calls, or to charge new services to their accounts as they are required. As noted in the BACKGROUND OF THE INVENTION above, the time of patient stays is continuously being reduced so administration of the patient telephone network is becoming less and less efficient. The invention provides a system where telephone accounts can be set up quickly and easily from the bedside, either by an attendant or the patient himself. In this respect, the invention adds up to an extra day to telephone sales and their associated revenues.

In the preferred embodiment described hereinafter, the account set up at step 38 will be time limited. That is, patients will be able to pre-pay the attendant in cash for a given number of days and the attendant will use a password to set the account up accordingly. Then, when the processing unit 24 receives a call request at step 40, the processing unit 24 will check to see whether the patient's account has timed out at step 42. If not, the request is granted at step 44 and control returns to the call request loop 40. If the account has timed out, the process simply terminates.

This automatic time check of accounts assures payment will be made and that telephone accounts will not inadvertently be left active.

The method of the invention also allows other “chargeable services” to be conveniently administered. The “chargeable service” may, for example, be the set up of the telephone account itself, making a long distance call, renting a television or ordering a pay-per-view feature for the user's television.

Detailed Description of Preferred Embodiments of the Invention

The preferred embodiment of the invention is an apparatus which facilitates the management of telephone rental in a hospital and is installed between the hospital PBX 12 and patient telephones 20 as noted above with respect to FIG. 2. Key features of the added functionality provided by the invention include, but are not limited to the following:

programming telephone rental from the bedside telephone 20 directly, rather than using the existing PBX 12 or existing LAN;

programming television rental via a PC/LAN connection;

automatically removing telephone and/or television service upon rental expiration;

concentrating PBX locals so that more telephones can be added without adding new input lines to the existing PBX 12, or increasing the number of PSTN lines;

originating in-hospital calls from non-rented telephones;

providing toll restrictions; and

potentially managing resale of toll charges with firmware/software enhancements.

Other functionality which the invention may provision would be clear to one skilled in the art from the teachings herein.

Unlike the software overlays known in the art, the invention is not limited by the functionality of the underlying PBX 12. The invention adds a new, independent management system which can be tied to other hospital systems such as the television LAN or nurse call systems.

In the description which follows, reference is made to the following service levels for patient telephones. Other configurations could also be used:

service level 0 (non-rented telephone)—with the optional concentrator, and if a circuit is available, the user may dial * and be allowed to make an internal call or emergency (911) call;

service level 1 (rented telephone)—user obtains direct access to PBX 12 on hook-off, receiving a dial tone from the PBX 12; and

service level 2 (rented telephone with long-distance)—user is allowed to dial long distance.

Non-Rented Telephone Interface

If a patient has not pre-paid for an account, he will only be able to make in-hospital calls on his telephone, or other calls as programmed in the toll restriction of the PBX 12. When a * is dialled by the user, the switch 28 connects the telephone 20 or the PBX 12 and the user hears the PBX 12 dial tone. Inbound calls are intentionally not supported. Exemplary control sequences may include:

To make call: * NUMBER (In-hospital calling only)

To enable rental: ##<password>1 nn where nn=number of days to rent

Rented Telephone Interface

Once the patient has set up an account the telephone will work normally except with possible toll restrictions to prevent long distance dialling, directory assistance access, or access to other chargeable services. Inbound calling requires that callers know the PBX local to which the telephone has been connected for the duration of the rental.

If the user wishes to disable the account early, that is, before the time out he programmed on account set up, he may enter the following, or a similar control sequence:

To disable rental: ##<password>0

Rack Design

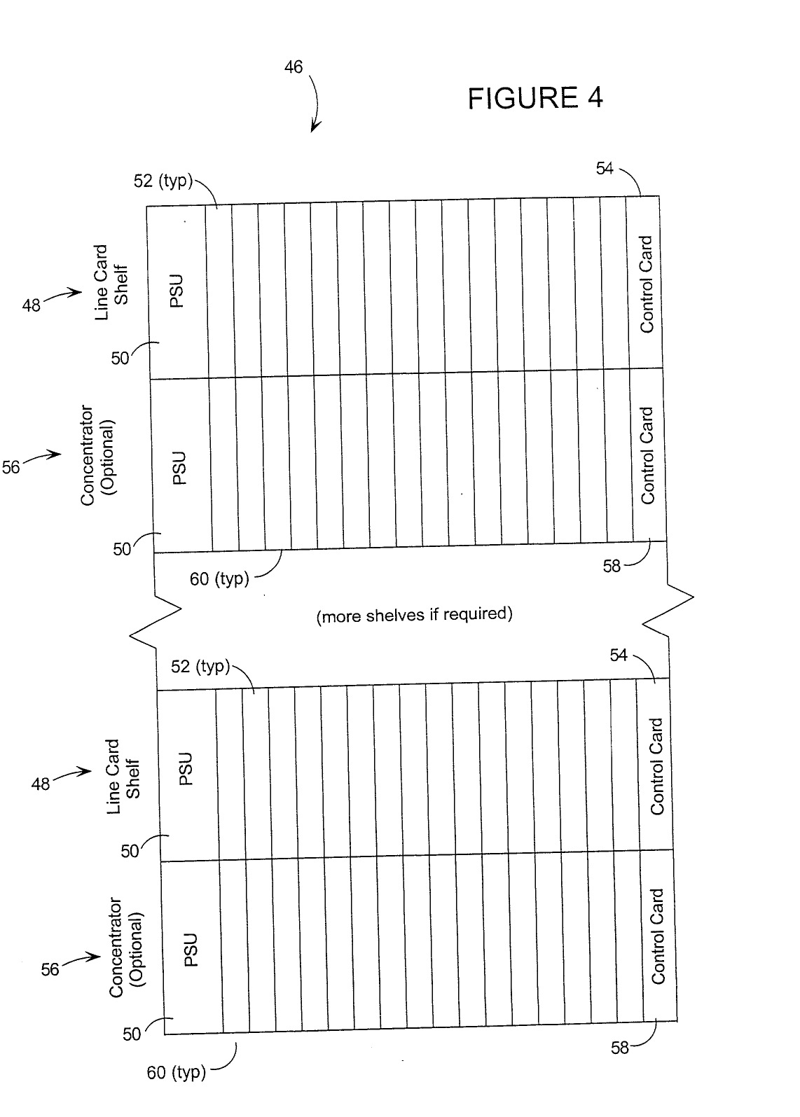

A physical layout of the preferred apparatus 46 of the invention is presented in FIG. 4, and consists of one or more line card shelves 48, each with a power supply 50 and capable of handling up to sixteen line cards 52. Each line card 52 is connected to as many as four PBX lines 22. One line control card 54 is required per line card shelf 48, the lowest address control card in the rack 46 functioning as the master system control card. Addressing is provided to allow control of up to 2048 PBX telephone lines 22 (4 lines per card×16 cards per shelf×32 shelves=2048).

The optional concentrator 56 has the capacity to support a fully loaded line card shelf 48 of sixty-four PBX telephone lines 22 and assigns one of sixteen available PBX local numbers to each rented account for the duration of its rental.

Spare PBX local numbers can be utilized for in-hospital calling by non-rented telephones if the lines are available. Each concentrator 56 is comprised of one shelf which includes one concentrator control card 58, power supply 50, and up to sixteen concentrator line cards 60. If a concentrator 56 is used, one concentrator line card 60 is required for each line card 52 in the line card shelf 48. The concentrator 56 is assigned the same address as the line card shelf 48 it serves.

Line Cards

The line card 52 administers almost all the functionality required by the user, except that communication with the line control card 54 is required to request services. The line card 52 responds to every poll by the master control card with a response that indicates the rental state and hook status for all four circuits, and whether or not it holds a message for the line control card 54 from one of the circuits. The rental state and hook status poll reply is utilized by the optional concentrator 56. The line card micro-controller has 4×64 byte registers for input/output to hold messages while waiting for polling.

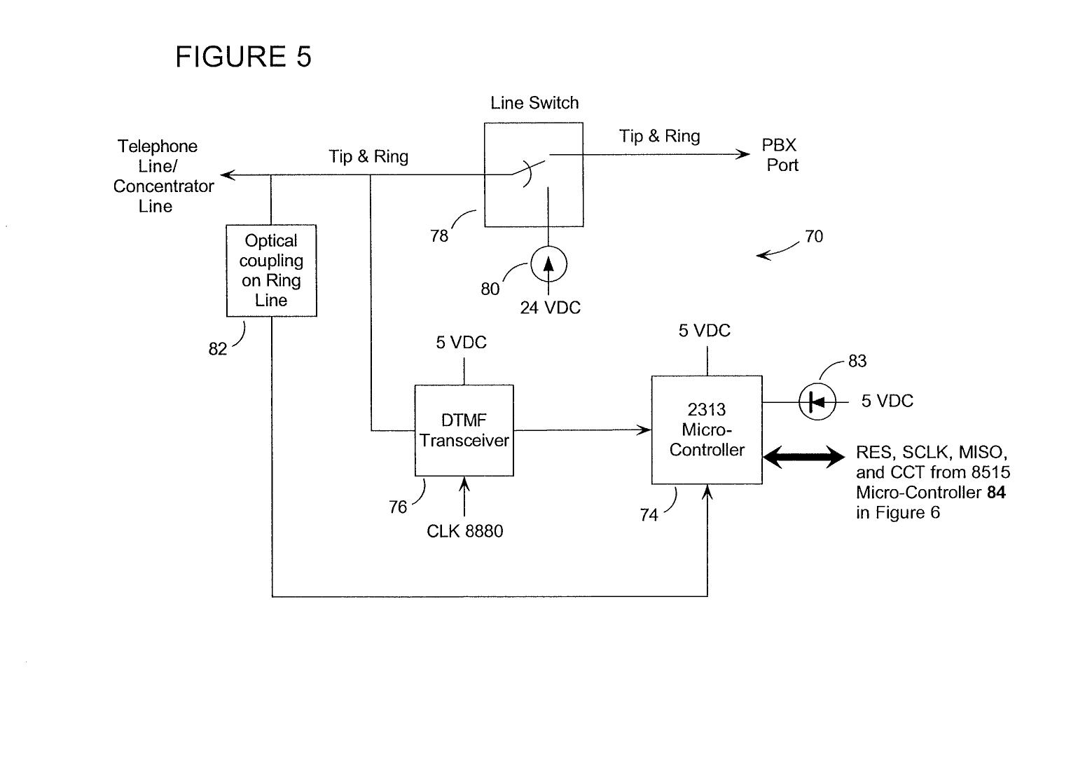

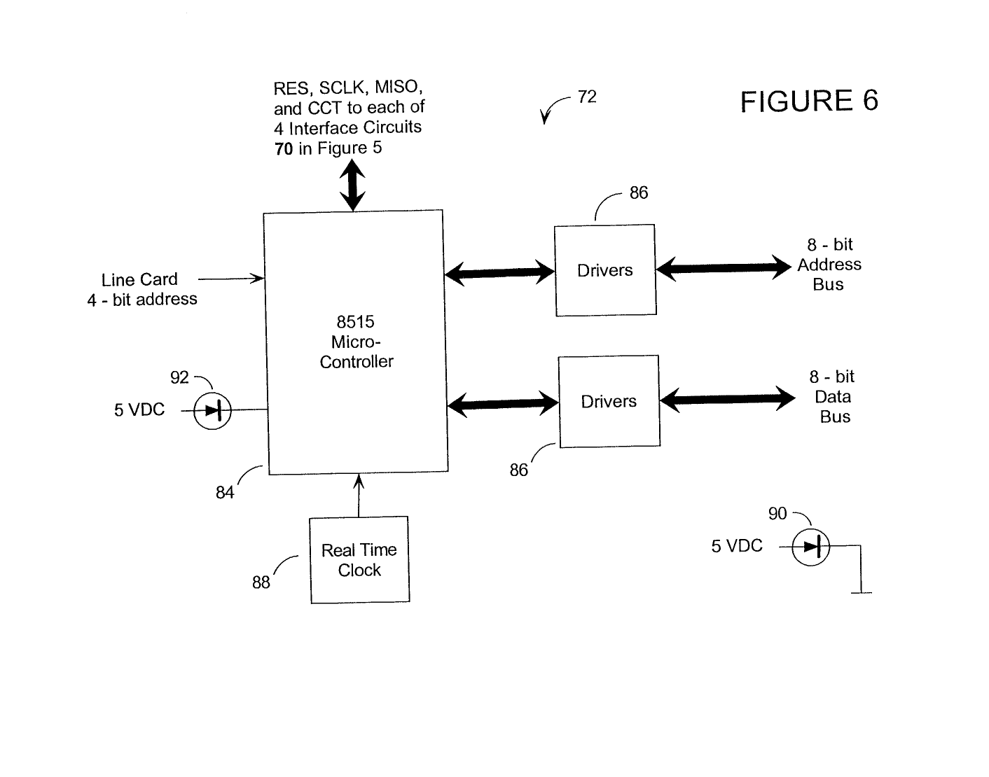

The preferred embodiment of a line card 52 is presented in the block diagrams of FIGS. 5 and 6. Each line card 52 contains four interface circuits 70 as presented in FIG. 5, and one 8515 micro-controller circuit 72 as presented in FIG. 6.

Each interface circuit 70 is managed by an Atmel 2313 micro-controller 74 with 128 bytes of internal EEPROM (Electrically Erasable Programmable Read-Only Memory). This EEPROM is used by the system to store toll restriction parameters, service level, rental expiration date and time, password, and in future would store financial credits for long distance services. The system uses this distributed memory to store system and circuit information that can be read and changed at either the circuit level or system level. The circuit level 2313 micro-controller 74 handles real time issues such as dual tone multifrequency (DTMF) signalling from the telephone 20, toll restriction, access, password verification, and monitoring of rental expiration date and time compared to current date and time.

Each circuit level 2313 micro-controller 74 communicates with 8515 micro-controller circuit 72 via the following signals:

RES—this reset line is used to enable and control the serial programming of the micro-controller;

MOSI (Master Out, Slave In)—a serial transmission line to transfer data from the master to the slave;

MISO (Master In, Slave Out)—a serial transmission line to transfer data from the slave to the master;

SCLK—each pulse on this serial clock line transfers one bit from the master to the slave on the MOSI line, and one bit from the slave to the master on the MISO line; and

CCT—chip select signal so that one and only one 2313 micro-controller 74 communicates with the 8515 micro-controller circuit 72 at a time.

DTMF encoding and decoding is provided by the DTMF transceiver 76 which is preferably a Mitel 8880C. The Mitel 8880C utilizes a switched capacitor D/A convertor and dial tone filter. It can also handle all 16 DTMF codes, so special functionality can be added to the invention using the four DTMF codes unavailable to a standard telephone.

Because DTMF is used to communicate between the telephones 20 and the line cards 52 rather than out-of-band or proprietary signalling, regular PSTN telephones can be used on the system of the invention. The more advanced PBX systems being offered today are sophisticated digital devices which are much more expensive. Of course, the invention can be implemented with either type of telephone 20.

The preferred line switch 78 is a telephony grade Omron G6K-2P-Y-DC24 or Aromat AG020024, rated to Bellcore 2.5 kV surge requirements and 5×10⁷ mechanical cycles. A 24VDC current source 80 is included to provide a talk battery to the telephone 20 while the switch 78 has the PBX 12 disconnected.

The optical coupling 82 on the tip and ring line is an NEC P2525-1, which has a high isolation voltage (BV=5000 V RMS), and contains an AC light emitting diode pair. Note that the tip and ring line is connected to either a telephone line or to an optical concentrator 56 line. The optical coupling 82 is used to monitor on- and off-hook status of the associated telephone 20, so the system knows for example, when a telephone 20 is picked up in response to an incoming call, and when the user hangs up (information that the DTMF transceiver 76 cannot provide). A light emitting diode (LED) 83 is also provided on the line card 52 to indicate the on- and off-hook status.

The 2313 micro-controller 74, DTMF transceiver 76, 24VDC current source 80 and any other components requiring power, obtain their power from the PSU (Power Supply Unit) 50 of the line card shelf 48.

As noted above, each line card 52 includes four of the interface circuits 70 of FIG. 5, as well as an Atmel 8515 micro-controller circuit 72 per FIG. 6, that provides a buffer between the four interface 2313 micro-controllers 74 and the line control card 54. By design, this 8515 micro-controller circuit 72 contains no feature affecting firmware so that future enhancements could be achieved with a code download to all system interface 2313 micro-controllers 74 which are in-circuit re-programmable. The 8515 micro-controller 84 is in-circuit programmable but is not capable of re-programming itself. It can however re-program the interface 2313 micro-controllers 74. The 8515 micro-controller 84 utilizes its 512 bytes of RAM for storing and handling messages between the control and circuit levels.

If there is a problem with a line 2313 micro-controller 74, the main 8515 micro-controller 84 ignores that particular line 2313 micro-controller 74 and deals with the others. As well, the 8515 micro-controller 84 may communicate with the 2313 micro-controllers 74 during the period between system polls (every 35 mS or so) for re-programming or other purposes.

The 8515 micro-controller circuit 72 also contains:

74HC245 bidirectional drivers 86 to drive the data and address buses of the line card 8515 micro-controller 84;

a 10 year battery to provide power on a utility failure (not shown);

a real time clock 88 needed for long distance dialling precision;

a an LED 90 (Light Emitting Diode) to indicate power on; and

an LED 92 to indicate that the line card 52 is being polled. This is done by switching the LED 92 on with every 40 polling cycles and off every 40 cycles.

As noted above, the 8515 micro-controller 84 on each line card 52 communicates with the interface circuits via the RES, MOSI, MISO, CCT and SCLK lines. However, it should be noted that there are separate RES and CCT lines for each of the four interface circuits 70, while the MISO, MOSI and SCLK lines are common to all four.

The 4-bit line card address is used to identify which of the 16 line cards 52 in the shelf 48 is being targeted. The 8-bit address and data buses are used to communicate actual programming data to and from the targeted line card 52.

Line Control Cards

As shown in FIG. 4, there is one line control card 54 for each line card shelf 48 in the rack 46. One line control card 54 is designated as the master, and the balance are slaves. This identification is made manually by setting a switch on the control card 54 itself. This is described in greater detail hereinafter.

The master control card provides system clock, system polling, real time clock, and the PC/LAN interface. Each line card 52 and interface circuit 70 in the system is polled approximately every 35 ms and queried as to whether it has any messages for the line control card 54. The master control card will poll all 32 shelves 48, regardless of how many are in use, so that the interval between polls is consistent.

Messages to the line control card 54 may include, for example:

responses to line control card 54 queries; and

rental service requests.

Messages from the line control card 54 to line cards 52 may be addressed or global, and include:

current date and time;

set service level 0 (service level 0 represents not rented, so there is no dial tone from the PBX 12. However, if the user enters *, the PBX 12 dial tone is provided to allow local calls);

set service level 1 until YY MM DD HH (that is, open a rental account that expires at that certain hour, and allow a dial tone to be received from PBX 12.

The system may be implemented in either daily or hourly increments;

reply with status and rental expiration;

reply with EEPROM content;

download EEPROM content; and

set to default programming.

Slave line control cards simply act as data repeaters to subsequent line card shelves 48 and concentrator shelves 56, and provide traffic functions for messages to the particular shelf 48 or 56.

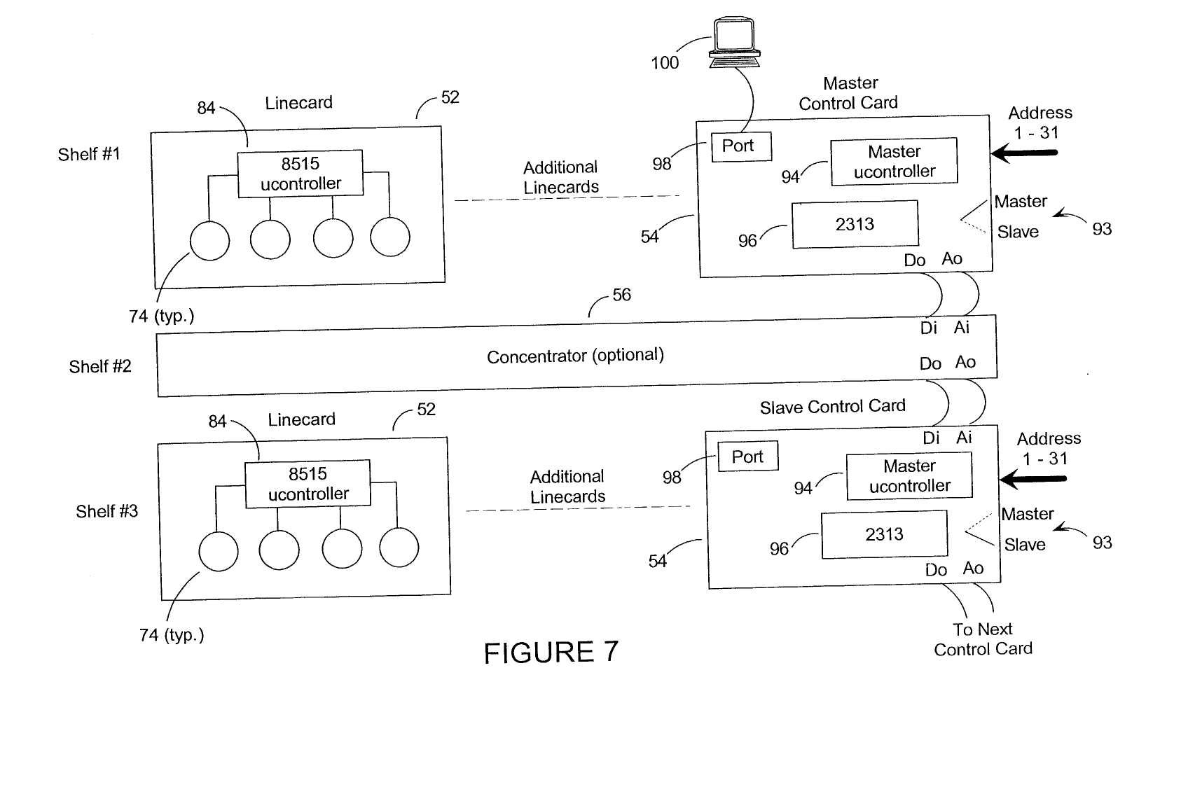

The preferred embodiment of a line control card 54 is presented with respect to the block diagram of FIG. 7. This figure presents two line card shelves 48 in a rack, though there could be as many as thirty-two line card shelves 48. As well, only one line card 52 is shown per shelf 48, though there could be as many as sixteen per shelf 48. It is significant to note that each line control card 54 has the following components:

a master/slave switch 93. As noted above, this switch is set manually, and only one line control card 54 will be set to master, while the balance will be set to slave;

an Atmel 8515 micro-controller 94 which performs polling of line cards 52, and maintains a real time clock if necessary (this 8515 micro-controller 94 is not to be confused with the 8515 micro-controllers 84 in each line card 52). A real time clock may also be provided by an external system such as a LAN, in which case the master control card will maintain the time locally and up date it periodically from the LAN. The master control card has a real time clock and can stand alone if necessary;

an Atmel 2313 micro-controller 96 which serves as the traffic cop for input and output (this 2313 micro-controller 96 is not to be confused with the four 2313 micro-controllers 74 per each line card 52); and

a port 98 connection to a terminal, USB card, personal computer (PC) or LAN 100. In the preferred embodiment, this port 98 is a serial connection, but it may be parallel, Ethernet, TCP/IP (Telecommunications Protocol over Internet Protocol) or other similar port as known in the art. While all line control cards 54 have such a port 98, only the master line control card will use it. Of course, the invention may operate independently of such an interface.

Each line control card 54 has its 5-bit address, so up to thirty-two line card shelves 48 can be addressed. Each control card 54 also has separate input and output busses for both data and address. Data input is represented as Di in FIG. 7, data output as Do, and correspondingly, address input is represented as Ai and address output as Ao. When a message arrives, it is checked by the micro-controller 94 to see if the shelf number matches, and the message is either acted upon or passed on to the next shelf.

Concentrator

The concentrator control card 58 constantly monitors the service level status and hook status of the line cards 52 it serves by monitoring the poll replies. This information is constantly transmitted across the shelf backplane to the concentrator line cards 60.

The control cards 54 and 58 for the line card shelf 48 and the concentrator shelf 56 use the same micro-controllers, but the two control cards 54 and 58 are different in design and the micro-controllers perform different functions.

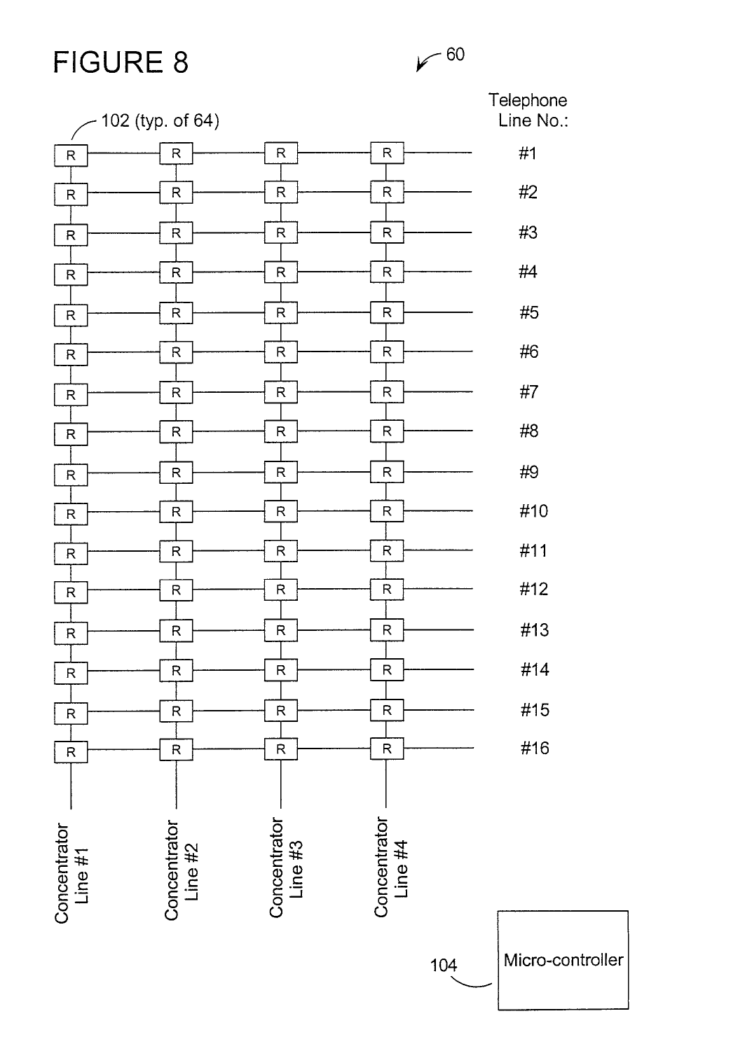

There is one concentrator line card 60 per line card 52. As per FIG. 8, each concentrator line card 60 contains sixty-four isolation relays 102 which can connect any of the four telephone-line/concentrator-line circuits of a line card 52 to any of sixteen telephone lines 22 as directed by the concentrator control card 58. Micro-controller 104 supervises actuation of the relays 102 (interconnections are not shown). The concentrator control card 58 also has sixteen LEDs (not shown), 1 per line, to serve as in-use indication.

Also, as noted above, the concentrator 56 can still route an in-hospital call to a telephone 20 at service level 0.

The concentrator 56 therefore allows more telephones 20 to be added to an existing PBX 12 even after it has been loaded to full capacity. As noted in the BACKGROUND TO THE INVENTION, increased capacity is often required as an organisation grows. According to the Erlang distribution, having access to even a small number of additional PSTN trunks 14 allows a large number of additional telephones 20 to be supported.

The concept of a concentrator 56 is known in the context of PSTN side services, but not on the telephone side to expand a PBX 12. In the case of the invention, each concentrator card 60 is under the control of a line card 52. Typically, a concentrator card 60 allows 16 telephones 20 to access 4 PBX lines, which allows for up to 25% rental. If demand for the telephone server is high however, one could underload the concentrator 56, for example, allowing only 8 telephones to be connected to each concentrator card 60, having 4 trunk lines.

PBX Setup

In order to implement the invention, a one-time setup of the PBX 12 is required:

usually every telephone 20 on the PBX 12 has a separate DID (Direct Inward Dialling) PBX local number, so no modifications are required of this aspect;

toll restrictions on the PBX 12 would have to be disabled; and

PBX 12 will continue to do voice mail and in hospital calls and does not become a simple concentrator.

With the toll restrictions of the PBX 12 disabled, the PBX 12 will perform any requested service regardless of the cost, so all cost restriction is deferred to the processing unit 24. Therefore, the processing unit 24 must intercept the beginning codes in a call request for any chargeable services, and determine whether the request can be allowed. If it is allowable, the processing unit 24 actuates the switch 26 to connect telephone 20 to the PBX 12, and the balance of the user's key entries will pass to the PBX 12.

The invention presents itself to the PBX 12 as if the incoming signal has been generated by a real and typical dialled number.

Architecture and Design

The shelves 48 and 56 provide local data bus and wiring connection only. No system functions are provided by the shelves 48 themselves. System communication is via separate 8-bit data and address buses.

Cards on the shelves 48 and 56 are interconnected via the backplane of the rack 46. Control cards 54 and 58 are interconnected with one another by ribbon cable.

The system administrator interfaces with the processing unit 24 by means of a computer interface of some sort. As many hospitals already have an industrial LAN (Local Area Network) infrastructure to run televisions, it is preferred to use the same LAN and terminal to interface with the processing unit 24 of the invention. In addition to being inexpensive, interconnecting the two systems lends itself to the charging of LAN services (such as television rental, and pay-per-view) via the system of the invention.

Part of the design philosophy is to put functionality as far upstream as possible, which is largely responsible for the number of micro-controller layers. For example, because there are four times as many interface circuits 70 as 8515 micro-controller circuits 72, any functionality that can be moved from the interface circuits 70 to the 8515 micro-controller circuits 72 will reduce the processing power required at the lower level, freeing up board space and reducing component count and overall cost. The same argument applies to the other processing layers of the system.

PC/LAN Interface

The options which would be made available to the operator at the PC/LAN interface include:

setting service level (rented, non-rented, long distance privileges, etc.);

changing password;

resetting circuits to default programming;

retrieving status information such as rental state, hook status, rental expiration; and

changing toll restrictions.

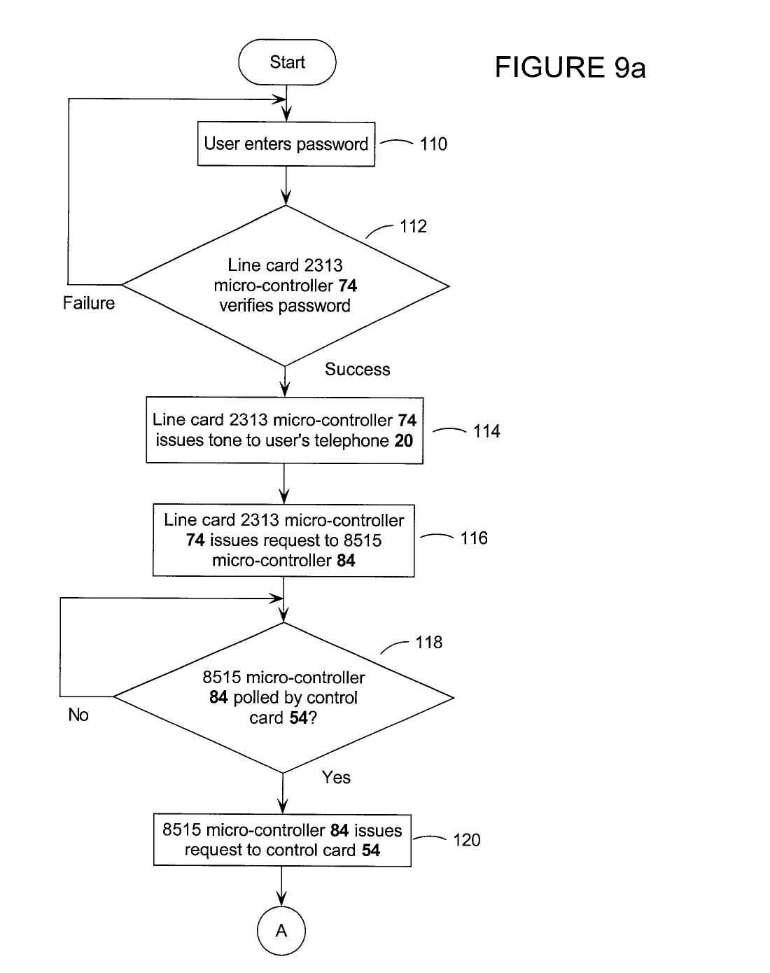

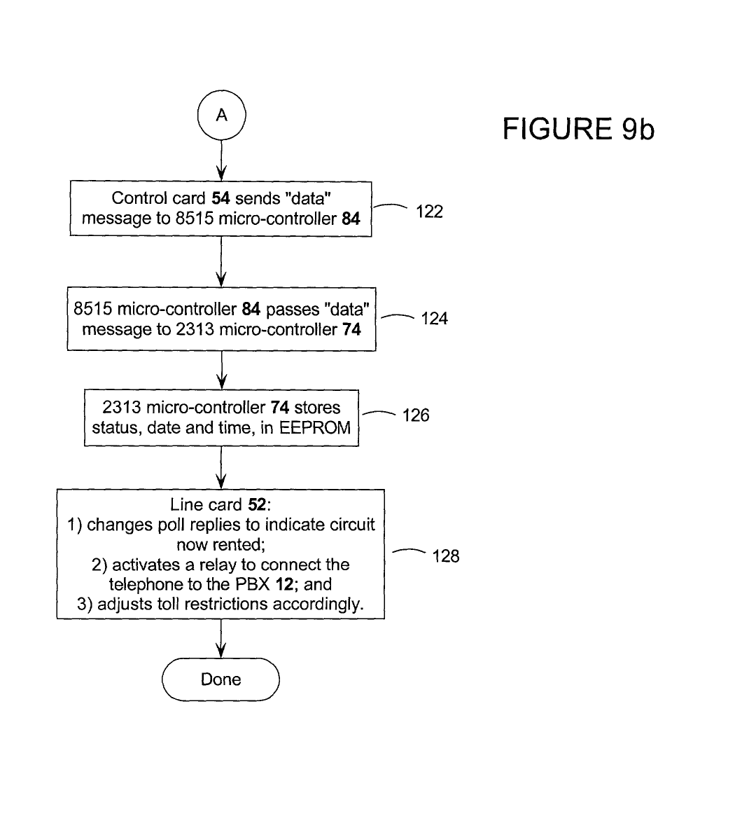

The algorithms for implementing such functionality is clear from the teachings herein. An example of how communications are achieved in the method of the invention is presented with respect to FIGS. 9a and 9b. These figures present a flow chart of how a patient sets up a service level 1 account using his telephone. The process begins when the patient picks up the telephone handset and dials ##<password>1 04 at step 110.

The 2313 micro-controller 74 hard wired to the user's telephone 20 receives this information and verifies that the correct password was entered at step 110. As noted above, any appropriate electronic payment or identification may be used rather than a simple password. Verification would be performed in a manner corresponding to the nature of the electronic payment or identification method.

If the verification is unsuccessful, control returns to step 110 to await another service request from the user. If the verification is successful, the 2313 micro-controller 74 provides a confirmation tone to the user's telephone 20 at step 114, and subsequently passes a message to the 8515 line card micro-controller 84 at step 116 that a request has been made for service level 1 (local dialling rental) for 4 days.

The 8515 micro-controller 84 sits in a loop at step 118 until it is polled by the control card 54. As noted above, this polling is done within 0-35 ms of the request, which passes this information up to the control card 54 at step 120.

The control card 54 then sends a data message to the 8515 micro-controller 84 at step 122 of FIG. 9b, that it has a message for the 2313 micro-controller 74 which tells it to change its service status to level 1 until date and time YY MM DD HH.

At step 124 the 8515 micro-controller 84 then passes this data message on to the 2313 micro-controller 74 corresponding with the patient making the request. The 2313 micro-controller 74 then stores this information in its internal EEPROM at step 126. Now, should the circuit status be queried through the PC/LAN connection the control card 54 will report using information it retrieves from the 2313 micro-controller 74 EEPROM.

At step 128, the line card 52, will now:

1. immediately change its poll replies to indicate that the circuit is now rented;

2. activate a relay to connect the telephone 20 to the PBX 12; and

3. adjust toll restrictions accordingly.

Also, if a concentrator 56 is installed in the system it will immediately assign telephone service to the corresponding circuit based on the line card 52 poll reply.

Each time that current date and time are transmitted by the control card 54 the 2313 micro-controller 74 will compare the current date and time to the expiration date and time (YY MM DD HH as noted above) and ensure that service should not expire.

Once current time and date match or surpass service level 1 expiration date and time then the 2313 micro-controller 74 will revert to service level 0 which automatically drops the concentrator 56. No report is sent to the control card 54 when this occurs.

If a PBX line 22 cannot be obtained, the user receives dead space, so the invention times out if there is no talk battery from the PBX 12 after 1 second. Therefore, it is important that the 2313 micro-controller 74 store the original call data so that a reference as to when the request was first made and how much time is left can be determined.

Alternatives

There are many possible alternatives to the design that has been presented. These would include:

1. a dial tone or ring could be generated at the line card 52. This was not done in the preferred embodiment due to space constraints, but could easily be done by adding a dial tone or ring generator for each telephone line 30;

2. use of the functionality of the invention to order or set up other services such as television rentals and pay-per-view;

3. functionality could be moved from one micro-controller to another, for example, one could have the line card 52 catch DTMF (Dual Tone Multi Frequency) long distance numbers and send request to control card 54;

4. could drive 4×128 from line micro-controller 74 to line card micro-controller 84 (512 bytes) and then return it;

5. regular PBX 12 can be set up to have default in hospital local;

6. could add multiple levels of password access; or

7. Interactive Voice Response (IVR) could be added to aid self-service to set up television, telephone and other services. This could be used to prompt user to enter the language preference, enter credit card number, and other parameters.

While particular embodiments of the present invention have been shown and described, it is clear that changes and modifications may be made to such embodiments without departing from the true scope and spirit of the invention.

Although aspects of the invention have been described with respect to method steps, clearly the invention may be embodied by a combination of software and hardware. The method steps may be executed by a computer processor or similar device suitably programmed, or may be executed by an electronic system which is provided with means for executing these steps. Similarly, an electronic memory means such as a computer diskette, CD-Rom, Random Access Memory (RAM) and Read Only Memory (ROM) may be programmed with coding to execute such method steps. As well, electronic signals representing these method steps may also be transmitted via a communication network.

Although the examples relate to telephones, the same principles may be applied to other devices on a telephone PBX networks including Personal Digital Assistants (PDA), laptop computers or voice digitizing software for voice over Internet applications.

The sets of executable machine code representative of the method steps of the invention may be stored in a variety of formats such as object code or source code. Such code is described generically herein as software, or a computer program for simplification. This executable code may also be transmitted as an electronic signal over communication links. As well, the executable machine code may be integrated with the code of other programs, implemented as subroutines, by external program calls or by other techniques as known in the art.

As well, the order and details of the method steps could easily be modified and still realize the benefits of the invention. Such modifications would be clear to one skilled in the art. The embodiments as presented herein are intended to be illustrative and not limiting.

What is claimed is:

1. An apparatus for adding functionality to a private telephone system, comprising:
a processing unit for monitoring a telephone line and operable to perform said added functionality;
a talk battery; and
a switch having an input for a telephone, and an output selectable between an input of said private telephone system and said talk battery, said switch being controlled by said processing unit.

2. The apparatus as claimed in claim 1, wherein said processing unit comprises: a pickup for monitoring on and off hook status of said telephone.

3. The apparatus as claimed in claim 2, wherein said processing unit comprises: a micro-controller.

4. The apparatus as claimed in claim 3, wherein said micro-controller further comprises:
a dual tone multifrequency (DTMF) transceiver for receiving DTMF signals from said telephone, decoding said DTMF signals into binary data, and transmitting said binary data to said micro controller.

5. The apparatus as claimed in claim 4, wherein said switch comprises:
a double pole double throw (DPDT) relay, one pole for a tip line and one pole for a ring line.

6. The apparatus as claimed in claim 5, wherein said micro-controller further comprises:
a flash ROM programmable to store user password data and access restrictions.

7. The apparatus as claimed in claim 6, wherein said talk battery comprises: a current source to drive said telephone via said tip and ring lines.

8. The apparatus as claimed in claim 7, wherein said pickup comprises: an optically isolated coupling for monitoring said ring line.

9. A method of adding functionality to an existing telephone and private telephone system, comprising the steps of:
monitoring a telephone line using a processing unit;
analysing monitored data within said processing unit; and
responding to an indication from said processing unit, by switching an input for a telephone, between an input of said private telephone system and a talk battery.

10. A system comprising:
at least one telephone;
a private telephone system;
an apparatus for adding functionality to said private telephone system including:
a processing unit operable to:
monitor a telephone line; and
perform said added functionality;
a talk battery; and
a switch having an input for a telephone, and an output selectable between an input of said private telephone system and said talk battery, said switch being operable to be controlled by said processing unit.

11. The system as claimed in claim 10, wherein said processing unit comprises: a pickup for monitoring on and off hook status of said telephone.

12. The apparatus as claimed in claim 11, wherein said processing unit comprises:
a micro-controller.

13. The apparatus as claimed in claim 12, wherein said micro-controller further comprises:
a dual tone multifrequency (DTMF) transceiver for receiving DTMF signals from said telephone, decoding said DTMF signals into binary data, and transmitting said binary data to said micro controller.

14. A line card for adding functionality to a private telephone system, said line card comprising:
a processing unit for monitoring a telephone line and operable to perform said added functionality; and
a switch having an input for a telephone, and an output selectable between an input of said private telephone system and a talk battery, said switch being controlled by said processing unit.

15. The line card as claimed in claim 14, wherein said processing unit comprises: a pickup for monitoring on and off hook status of said telephone.

16. The line card as claimed in claim 15, wherein said processing unit comprises: a micro-controller.

17. The line card as claimed in claim 16, wherein said micro-controller further comprises:
a dual tone multifrequency (DTMF) transceiver for receiving DTMF signals from said telephone, decoding said DTMF signals into binary data, and transmitting said binary data to said micro controller.
